(19) United States
(12) Patent Application Publication
(10) Pub. No.: US 2005/0279441 A1
(43) Pub. Date: Dec. 22, 2005

(54) Ultrasonic bonding of filter elements to end caps

(76) Inventors: John R. Warfield, Fayetteville, NC (US); Randy C. Frye, Fayetteville, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/873,794

(22) Filed: Jun. 22, 2004

(51) Int. Cl. B29C 65/00; B29C 65/08

(52) U.S. Cl. 156/73.1; 156/580.1

(57) ABSTRACT

A manufacturing system and a method of producing a filter assembly for use in a filter is provided. The filter assembly includes a filter media, such as a pleated paper filter element, and opposing end discs secured to the filter media by a liquid bonding agent. The manufacturing system employs the method of dispensing the liquid bonding agent onto the end discs. Opposing ends of the filter media are inserted into the liquid bonding agent. The end discs are ultrasonically excited at one or more stations to heat the liquid bonding agent to a cure temperature.

### BACKGROUND OF THE INVENTION

The present invention relates to a filter assembly manufacturing system and method using ultrasound to bond a filter media to end discs of the filter assembly.

Fluid filters incorporate a filter assembly for filtering debris from fluid flowing through the filter. One typical arrangement for fluid filter applications includes a filter assembly having a pleated paper filter media captured between a pair of opposing end discs. A center tube may be arranged between the end discs and located centrally within the filter media to provide further structural rigidity to the filter assembly. A suitable bonding agent, such as a liquid vinyl, is dispensed onto the end discs. The end discs are installed onto opposing ends of the filter media to form the filter assembly.

The filter media and end discs enter an oven where the bonding agent is heated and cured. The oven where the filter assembly is cured may be of a considerable length, and the filter assembly may require heat exposure for a significant length of time. As a result, a long assembly line is required to incorporate the oven for heating and curing the bonding agent. It is desirable to reduce the assembly line length and the cycle times associated with curing the bonding agent.

### SUMMARY OF THE INVENTION

The invention provides a manufacturing system and a method of producing a filter assembly for use in a fluid filter such as an oil filter. The filter assembly includes a filter media, such as a pleated paper filter element, and opposing end discs secured to the filter media by a bonding agent.

The manufacturing system includes a bonding agent dispenser for dispensing the bonding agent onto the end discs. The bonding agent is heated to a pre-gel temperature to reduce cycle time associated with curing the bonding agent. An ultrasonic assembly includes a horn that engages the end discs to apply a desired pressure to one of the end discs. The end disc is vibrated at a desired frequency for a desired duration to excite the end disc thereby generating heat. The vibration heats the bonding agent to a cure temperature at which the bonding agent is cross-linked.

More specifically, the manufacturing system employs a method of dispensing a bonding agent onto the end discs. Opposing ends of the filter media are inserted or embedded into the bonding agent. The end discs may be ultrasonically excited at one or more stations to heat the bonding agent to a cure temperature. Depending upon the consistency of the bonding agent, the filter media may be inserted into the bonding agent of one end disc and ultrasonically cured, or both end discs may be mounted to the filter media and cured.

Accordingly, the present invention provides a manufacturing system and associated method of manufacturing a filter assembly in which assembly line length and cycle time associated with curing the bonding agent is reduced.

These and other features of the present invention can be best understood from the following specification and drawings, the following of which is a brief description.

### BRIEF DESCRIPTION OF THE DRAWINGS

FIG. 1 is a cross-sectional view of a filter assembly shown within a filter, which is indicated in phantom.

FIG. 2 is a schematic view of one example manufacturing system and method.

FIG. 3 is a schematic view of an ultrasonic assembly used to cure the bonding agent of the filter assembly.

FIG. 4 is another schematic view of one example manufacturing system and method.

### DETAILED DESCRIPTION OF THE PREFERRED EMBODIMENT

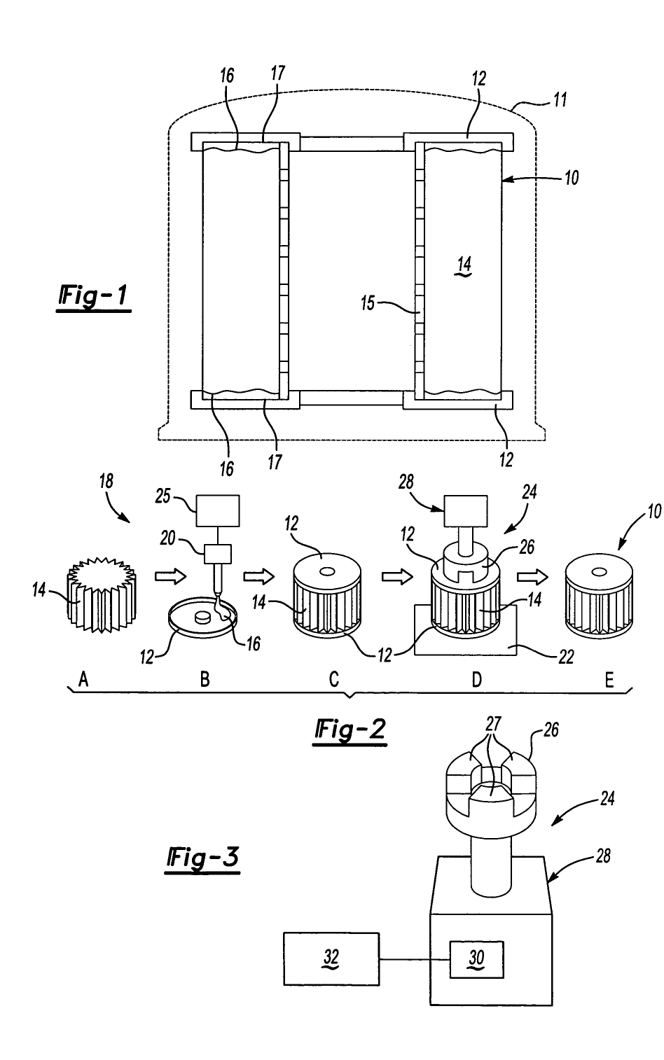

A filter assembly 10 is shown schematically in FIG. 1. The filter assembly 10 is used for various fluid filtering applications. One example application is for use as an oil filter that includes an oil filter housing, shown in phantom at 11 in FIG. 1.

The filter assembly 10 includes opposing end discs 12 with a filter media 14 captured between the end discs 12. The filter media 14 is a pleated paper element in the example shown. However, it should be understood that the filter media 14 may be constructed from any suitable material and arranged in any suitable configuration based upon the filter assembly application. A center tube 15 may be used between the end discs 12 to increase the structural rigidity of the filter assembly 10 and prevent the filter media 14 from collapsing inwardly under pressure.

An adhesive such as a bonding agent 16, which is liquid at room temperature, secures opposing ends 17 of the filter media 14 to the end discs 12 when cured. The bonding agent 16 may be any suitable material such as plastisol, hot melt glue, polyurethane, or any other suitable material. The selection of an appropriate material may depend upon cost, pre-gel and cure temperatures, processability, and the environment to which the bonding agent is exposed within the filter assembly 10.

FIG. 2 depicts an example manufacturing system and associated method for forming the inventive filter assembly 10. Letters are used to indicate various stages associated with the process, however, it should be understood that the stages may be arranged in a sequence other than shown and stages may be added or deleted and still fall within the scope of the invention.

The filter media 14 is provided at stage A in a manner known in the art. The bonding agent 16 is dispensed onto the end disc 12 by a dispenser 20 at stage B. In the example shown, a heat source 25 is used to heat the bonding agent 16 to a pre-gel temperature in which the bonding agent 16 is more viscous. In this manner, both end discs 12 may be installed onto the filter media 14 simultaneously prior to curing without the bonding agent 16 running down the filter media 14, which would undesirably reduce its filtering surface area. The pre-gel temperature is a temperature at which the bonding agent 16 thickens without cross-linking, which occurs at a higher curing temperature.

As an alternative to heating the bonding agent 16 to a pre-gel temperature at the dispenser 20, an oven may be used subsequent to dispensing the bonding agent 16 onto the end discs 12 to heat the bonding agent 16 to the pre-gel temperature, which would better enable both end discs 12 to be mounted onto the filter media 14 prior to curing.

An uncured filter assembly is provided at stage C. The uncured filter assembly enters stage D where ultrasound is used to heat the bonding agent 16 to a cure temperature at which the bonding agent 16 cross-links. The bonding agent 16 then cools to a solid state. An ultrasonic assembly 24 shown at stage D is used to ultrasonically excite and heat the bonding agent 16.

The ultrasonic assembly 24 is schematically shown in FIG. 3. The ultrasonic assembly 24 includes a horn 26 having segmented engagement surfaces 27. The segmented engagement surfaces 27 engage the end discs 12, which are spaced from one another to reduce the possibility of burning the bonding agent 16. The horn 26 clamps the uncured filter assembly between the horn 26 and a support surface 22 (see FIG. 2) to apply a desired pressure to the end disc 12. A base unit 28 supporting the horn 26 includes an amplifier and power booster 30 that vibrates the horn 26 at a desired frequency for a desired duration in response to commands from a controller 32.

The desired parameters of pressure, frequency, and duration at which the horn 26 vibrates the end disc 12 are dependent upon the material used for the bonding agent 16, the cure temperature desired, the cycle time desired, and numerous other factors. These desired parameters and the configuration of the horn 26 are selected to ensure that heat is generated uniformly to provide a uniform cure of the bonding agent 16 without burning the bonding agent 16. Using the ultrasonic assembly 24 results in a shorter assembly line with reduced cycle times associated with curing the bonding agent 16. A finished cured filter assembly 10 is shown at stage E.

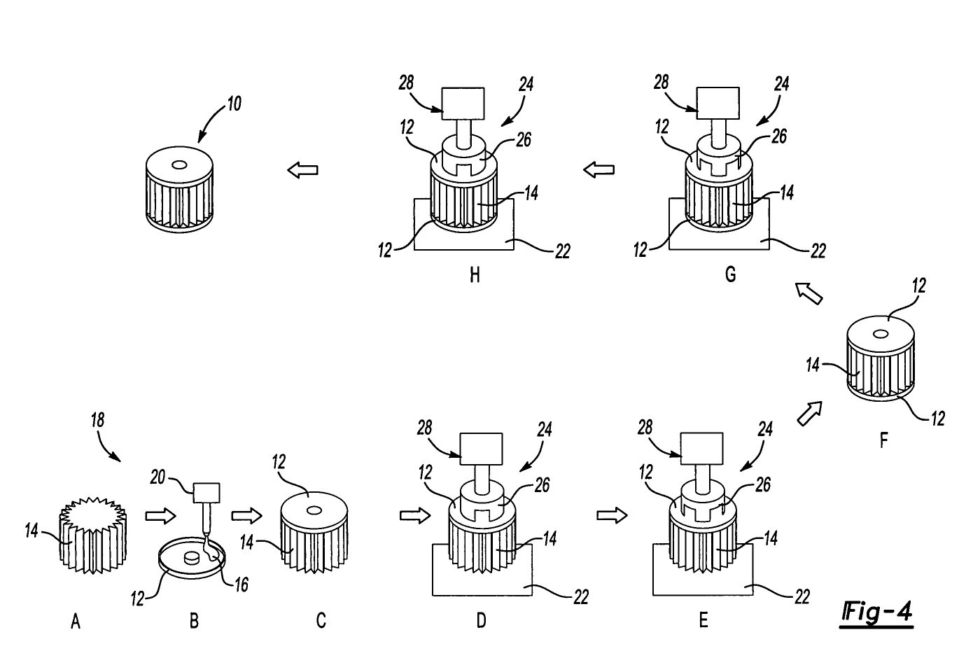

Another inventive manufacturing system and method is shown schematically in FIG. 4. The filter media 14 of stage A is installed onto an end disc 12 having bonding agent 16 dispensed onto the end discs 12 at an ambient temperature in stage B. This provides a partial filter assembly, shown at stage C. Stages D-H cure one end disc 12 to the filter media 14 at a time to prevent the bonding agent 16 from running down the filter media 14 since the bonding agent 16 is not very viscous at ambient temperature.

Referring to stage D, the horn 26 ultrasonically excites the end disc 12 at a desired pressure, frequency, and duration. To prevent overheating and burning of the bonding agent 16, the end disc 12 at stage D is not ultrasonically excited to achieve a full cure of all of the bonding agent 16. Instead, multiple stages are used to cure portions of the bonding agent 16. The partial filter assembly is transferred from stage D to stage E to finish ultrasonically exciting the end disc 12. The end disc 12 and the underlying bonding agent 16 are rotated to a different position relative to the segmented engagement surfaces 27 than that used at stage D to ultrasonically excite a different area of the end disc 12.

Another end disc 12 is installed onto the partial filter assembly, as shown at stage F. The uncured bonding agent 16 on the recently installed end disc 12 is ultrasonically excited and cured at stages G and H in a similar manner to that described above relative to stages D and E. A fully cured filter assembly 10 is provided at stage I.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of manufacturing a filter assembly comprising:
ultrasonically bonding a filter media to an end disc, by beating a bonding agent to bond the filter media to the end disc through ultrasonic excitation.

2. A method of manufacturing a filter assembly comprising the steps of:
a) dispensing a bonding agent between an end disc and a filter media; and
b) ultrasonically exciting the end disc and heating the bonding agent to a cure temperature.

3. The method according to claim 2, wherein the bonding agent is a liquid bonding agent.

4. The method according to claim 2, wherein step a) includes dispensing the bonding agent onto the end disc and inserting the filter media into the bonding agent.

5. The method according to claim 4, including the step of heating the bonding agent to a pre-gel temperature prior to inserting the filter media into the bonding agent.

6. The method according to claim 5, wherein stop a) includes dispensing the bonding agent at the pre-gel temperature that is less than the cure temperature.

7. The method according to claim 5, wherein step a) includes inserting the filter media into the bonding agent on opposing end discs prior to performing step b).

8. The method according to claim 3, wherein step a) includes dispensing the liquid bonding agent at approximately an ambient temperature.

9. The method according to claim 2, wherein step b) includes engaging the end disc with an ultrasonic horn, loading the end disc to a desired pressure, and exciting the end disc with the ultrasonic horn for a desired duration at a desired frequency.

10. The method according to claim 9, wherein step b) is performed using multiple ultrasonic horns.

11. The method according to claim 10, wherein the multiple ultrasonic horns include first and second horns, the first horn curing a first portion of the bonding agent and the second horn curing a second portion of the bonding agent.

12. The method according to claim 11, wherein the first and second horns are segmented, and the end disc is rotationally positioned differently between the first and second horns.

13. The method according to claim 2, wherein the filter media is a paper pleated filter media.

14. A manufacturing system used to produce a filter assembly that includes a filter media, a bonding agent, and an end disc, the manufacturing system comprising:
a bonding agent dispenser for dispensing the bonding agent onto the end disc; and
an ultrasonic assembly having a horn, the horn used for applying a desired pressure to the end disc and vibrating the end disc at a desired frequency for a desired duration to heat the bonding agent to a cure temperature.

15. The manufacturing system according to claim 14, wherein the horn includes spaced apart engagement surfaces for engaging the end disc and applying the desired pressure and vibration at the desired frequency and desired duration.

16. The manufacturing system according to claim 14, including a heat source for heating the bonding agent to a pre-gel temperature that is less than the cure temperature.
